(19) United States
(12) Patent Application Publication
(10) Pub. No.: US 2017/0231433 A1
(43) Pub. Date: Aug. 17, 2017

(54) Slicer

(71) Applicant: Bobby Khubani, Fairfield, NJ (US)

(72) Inventor: Bobby Khubani, Fairfield, NJ (US)

(21) Appl. No.: 15/425,536

(22) Filed: Feb. 6, 2017

Related U.S. Application Data
(60) Provisional application No. 62/291,307, filed on Feb. 4, 2016.

(51) Int. Cl. A47J 43/28; B26B 27/00

(52) U.S. Cl. CPC A47J 43/28; B26B 27/002

(57) ABSTRACT

A slicer is provided herein that includes a pair of parallel planar arms having a proximal end and a distal end, each of the arms coupled to each other at the proximal end via a hinge connection and at the distal end via a cutting wire. The apparatus is configured to be operated between a first position in which the pair of planar arms are essentially parallel to each other and a second position in which the pair of planar arms are squeezed closer to each other, and where the cutting wire is sufficiently rigid to maintain the distance at the distal end of the apparatus between the first and second positions.

### CROSS REFERENCE TO RELATED APPLICATION

This application claims the priority of U.S. Provisional Application No. 62/291,307, entitled “Slicer,” filed on Feb. 4, 2016, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Field of the Invention

This application generally relates to a food slicer, and in particular, an apparatus for slicing and grabbing food items, such as melons, cake, and the like.

Description of the Related Art

Certain foods, such as watermelons, cantaloupe, honey dew, and other melons can be very difficult to slice. Their large and round size makes them difficult to hold, creating the possibility of an injury when trying to handle them with one hand while slicing them with the other. Additionally, slicing foods such as cakes using traditional knives is messy and results in cutting uneven pieces. There is therefore a need for an improved food slicer that is not so limited.

### SUMMARY OF THE INVENTION

In at least one aspect, a slicer is provided herein that a pair of parallel planar arms having a proximal end and a distal end, each of the arms coupled to each other at the proximal end via a hinge connection and at the distal end via a cutting wire, the apparatus configured to be operated between a first position in which the pair of planar arms are essentially parallel to each other and a second position in which the pair of planar arms are squeezed closer to each other, and wherein the cutting wire is sufficiently rigid to maintain the distance at the distal end of the apparatus between the first and second positions.

In at least one embodiment, the hinged connection and the arms form a general U-shaped.

In at least one embodiment, at least the planar arms are formed from a sheet material.

In at least one embodiment, the material is at least one of a metal or plastic.

In at least one embodiment, the material is stainless steel.

In at least one embodiment, the hinge and the pair of arms are formed from a continuous sheet of material.

In at least one embodiment, at least one of the arms has blade edge on a top side of the apparatus.

In at least one embodiment, at least one of the arms has a generally U-shaped profile.

In at least one embodiment, at least one of the arms has a concave top side.

In at least one embodiment, at least one of the arms has a convex bottom side.

In at least one embodiment, at least one of the arms has a concave top side having a curve with first radius and a convex bottom side with a curve having a second radius, the second radius greater than the first.

In at least one embodiment, the concave top side has a blade edge thereon.

In at least one embodiment, the radii are located such that the outer edges of the arms come to a point at the distal end of the slicer.

In at least one embodiment, the planar arms are spaced between about ½ and about 3 inches from each other in the first position.

In at least one embodiment, the planar arms are spaced between about 1 and about 2 inches from each other in the first position.

In at least one embodiment, the hinge connection forms a flexible connection that allows the arms to move relative to each other with an application of a squeezing force applied at about the distal end of the apparatus.

In at least one embodiment, the application of the squeezing force causes the arms to bend inwardly toward each other thereby shortening a distance between the arms and wherein removing the force causes the arms to return to the first position.

In at least one embodiment, the apparatus includes a handle portion molded over the arms and the hinge connection at the distal end of the apparatus.

In at least one embodiment, at least one of the arms has an edge with a plurality of teeth located thereon.

In at least one embodiment, the teeth lay in the same plane as the respective planar arm.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a perspective view of a slicer according to an embodiment of the present invention;

FIG. 2 illustrates a front view of the slicer according to an embodiment of the present invention;

FIG. 3 illustrates a rear view of the slicer according to an embodiment of the present invention;

FIG. 4 illustrates a left-side view of the slicer according to an embodiment of the present invention;

FIG. 5 illustrates a right-side view of the slicer according to an embodiment of the present invention;

FIG. 6 illustrates a top view of the slicer according to an embodiment of the present invention;

FIG. 7 illustrates a bottom view of the slicer according to an embodiment of the present invention.;

FIG. 8A, 8B, 8C, and 8D illustrate cutting function of the slicer according to embodiments of the present invention; and

FIG. 9 illustrates a cross section of a cut produced by the slicer according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

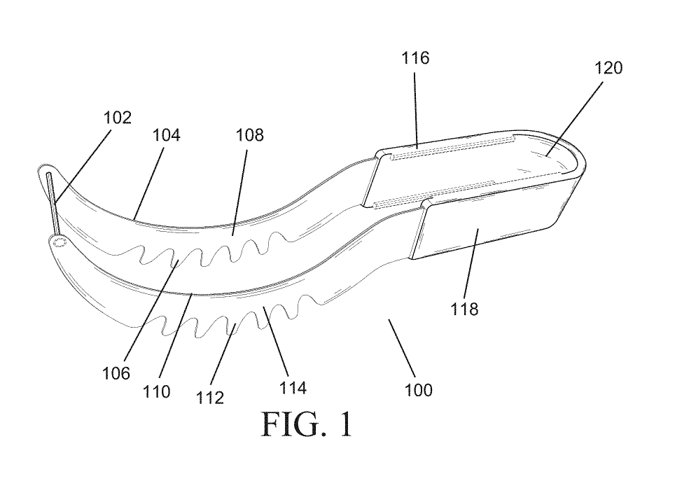

A slicer is described herein that is designed to quickly and easily cut, remove, and serve slices of food. Referring to FIG. 1, a slicer 100 according to one embodiment is depicted. The slicer 100 includes cutting wire or post 102 (hereinafter referred to simply as wire), first arm 108, a second arm 114, and hinge section 120. The arms 108 and 114, and hinge section 120 form a generally U-Shaped structure as shown. That is, the hinge section 120 joins together the arms 108, 114 at a proximal end of the slicer 100 to form the general U-shape. Moreover, the arms 108, 114 are joined together at the distal end of the slicer 100 via the wire 102. The wire 102 is preferably connected slightly away from the edges of the arms 108, 114, which helps prevent from cutting into, for example, the rind of fruit. The arms 108, 114 are preferably made from a planar sheet of a desired material, such as stainless steel or any other suitable material, including copper, ceramic, plastic, etc., and are generally parallel to each other. The arms 108, 114 and hinge section 120 may be formed from a continuous sheet of material, bent or otherwise formed into the desired shape.

One or both of the arms 108, 114 have a concave (top) side. More particularly, the arms 108, 114 may have a generally U-shaped profile with a concave top side and a convex bottom side. The slicer 100 may include a first blade edge 104 on the concave (top) side of first arm 108 and a second blade edge 110 on the concave (top) side of second arm 114. First blade edge 104 and second blade edge 110 may comprise a chisel edge or any other edge style such as a V-edge, convex, hollow, and serrated. In this regard, the slicer 100 has three cutting surfaces: the top sides of the arms 108, 114 and the wire 102. For example, when one is slicing a melon with the slicer 100 the arms 108, 114 are used to cut the sides of the melon slice while the wire 102 separates the melon fruit from the rind. First arm 108 and second arm 114 are positioned parallel (or substantially parallel) to each other, to produce uniform slices of food items. In one embodiment, the first and second blade edges 104, 110 have a curvature with smaller radii than the outer edges of the arms such that the arms 108, 114 come to a point at the distal end of the slicer 100.

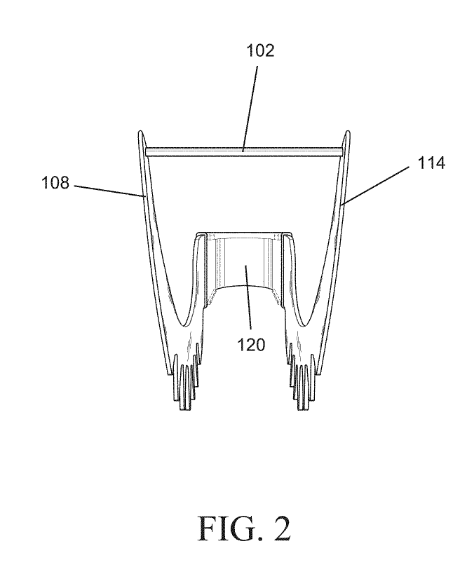

Wire 102 links first arm 108 to second arm 114 on a front end (e.g., as shown by FIG. 2). The wire 102 is sufficiently rigid to maintain the distance between arms 108, 114 at the distal end of the slicer 100 during normal use. That is, the wire is incompressible axially with the force (e.g., about 1-5 lbs.) applied laterally to the arms 108, 114 to grasp food items. In this regard, the distance between the arms 108 and 114 will remain constant at the distal end as the user squeezes the handles laterally together to pinch food items between the arms 108, 114, as discussed in greater detail below. It is understood that the dimensions of the slicer 100 may vary according to the particular use. In a preferred embodiment, the distance between the arms 108, 114 is between about ½ inches to about 3 inches, or preferably between 1 inch and about 2 inches. The overall length of the slicer 100 between proximal and distal ends is between about 4 and about 12 inches.

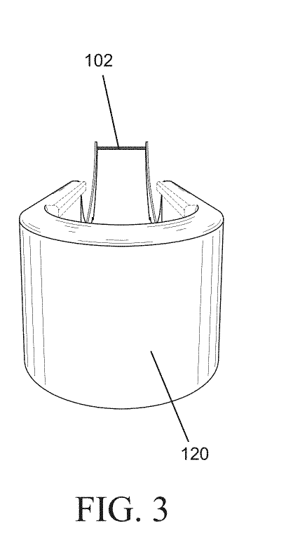

FIG. 3 presents the opposite or proximal end of slicer 100 from the perspective of the user holding the slicer for use. First arm 108 is coupled to second arm 114 by hinge section 120 on the proximal end opposite from the wire 102. Hinge section 120 may be U-shaped as shown, which joins first arm 108 with second arm 114, to act as a flexible connection that allows the arms 108, 114 to move relative to each other with the application of a normal force in a direction essentially perpendicular to the plane of the arms 108, 114 for grabbing food items placed between the arms. That is, during use, the application of a squeezing force causes the arms 108, 114, to bend inwardly toward each other (as a result of the wire 102) thereby shortening the distance between the arms 108, 114. In this regard, food placed between the arms 108, 114 will be held in place between the arms 108, 114 for serving until released. Upon removal of the squeezing force, the arms 108, 114 return to their original essentially parallel position as a result of the resiliency in the arms 108, 114 and/or hinge section 120. This eliminates the need for a separate utensil for cutting and serving the food item.

Each of arms 108 and 114 may further include handle portions 116 and 118, respectively. Handle portions 116 and 118 may be held and squeezed together by the user for grabbing food items between arms 108 and 114. Handle portions 116 and 118 may include a grip covering constructed of materials such as plastic or rubber. In this regard, as the slicer is squeezed, the distance between the arms at the front end of the wire 102 remains essentially constant while the portion of the arm along blade edges 104, 110 narrows to pinch food items between the arms 108, 114.

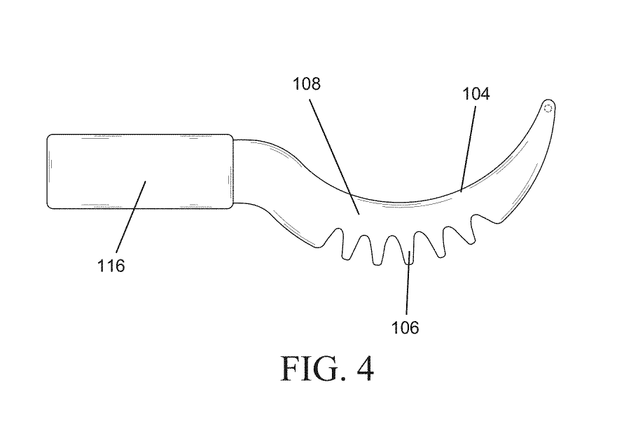

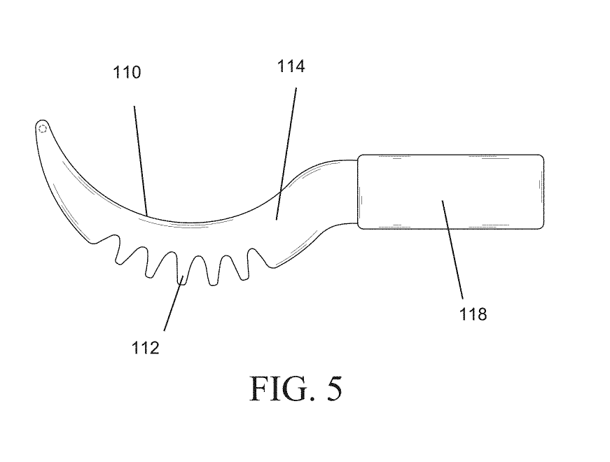

FIG. 4 and FIG. 5 presents left and right sides of the slicer. Convex (bottom) side of arm 108 and arm 114 may include teeth 106 and teeth 112, respectively. Teeth 106 and teeth 112 may assist in digging into a confined area or between slices of food items to grab a piece of the sliced food items with the convex side of slicer 100. The teeth 106, 112 preferably lay in the plane of the arms 108, 114, respectively, so as not to interfere with the cutting capability of the slicer 100.

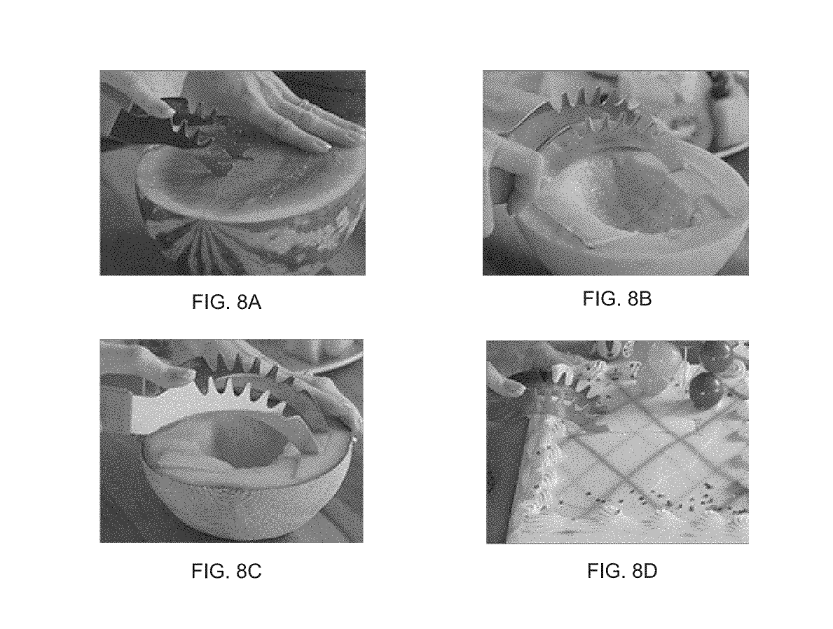

Slicer 100 may be used to slice into food items as indicated herein. Various food items are contemplated, including a watermelon, honeydew, cantaloupe, and cake. For melons, they are initially cut into semi-spherical halves. Thereafter, the distal end of the slicer 100 is inserted into the melon near the rind with the blade edges 104, 110 facing inward toward the fruit. The blade edges 104, 110 cut the left and right edges, respectively, of the food, while the wire 102 cuts the fruit from the rind as the slicer is draw across opposing sides of the fruit. The slicer 100 may be inserted into the food item using wire 102 to produce a cut perpendicular to and in conjunction with a parallel cut produced in the food item by blade edges 104 and 110. FIG. 8A, 8B, 8C, and 8D presents exemplary application of slicer 100 using the blade edges of the arms. Slicer 100 may cut wedges or cubes (e.g., by slicing a second time at a 90-degree angle to a first slice) in food items.

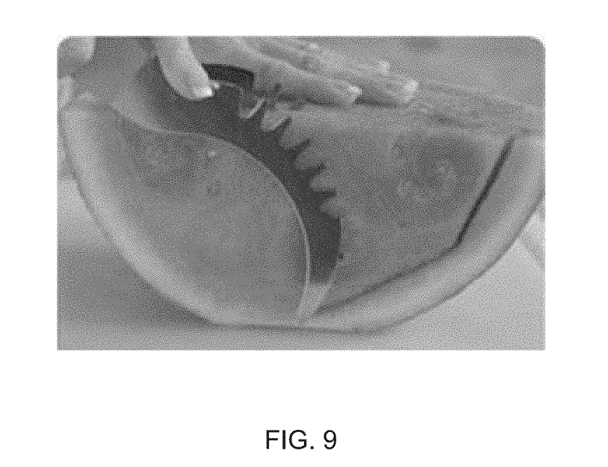

FIG. 9 presents a cross section of a cut produced by the slicer according to an embodiment of the present invention. As illustrated, slicer 100 is capable of cutting a wedge of a food item with a single slicing motion. Food items cut by slicer 100 may be sliced into a shape conforming to the space formed between the arms 108 and 114 configured in parallel with each other.

Slicer 100 also includes tong functionality for grabbing food items. Food items may be grabbed using the teeth 106 and 112 (on the convex side of arms 108 and 114) facing towards the food items. Alternatively, food items may also be grabbed using the concave side of arms 108 and 114 facing towards the food items. Regardless of the position of the slicer 100, food items may be placed in between the space between the arms 108 and 114 and grabbed by squeezing together handle portions 116 and 118. Squeezing together handle portions 116 and 118 causes a narrowing and compression in a region along arms 108 and 114 between the wire 102 and the handle portions 116 and 118 for gripping food items.

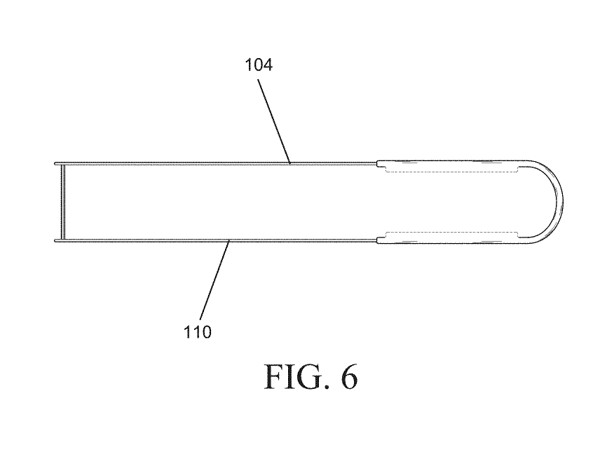

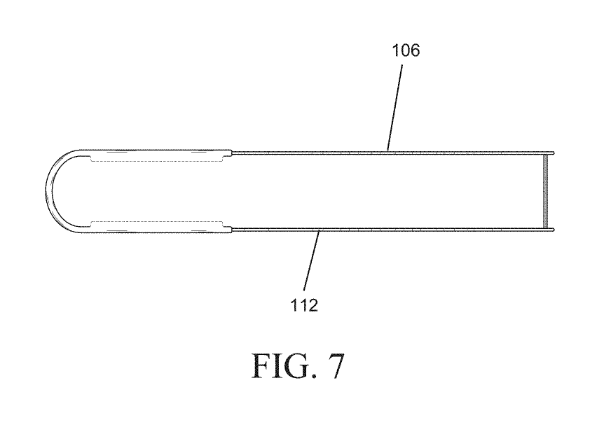

FIGS. 1 through 9 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A slicer apparatus comprising:
a pair of planar arms having a proximal end and a distal end, the arms coupled to each other at the proximal end via a hinge connection and at the distal end via a cutting wire, the apparatus configured to be operated between a first position in which the pair of planar arms are essentially parallel to each other and a second position in which the pair of planar arms are squeezed closer to each other, and wherein the cutting wire is sufficiently rigid to maintain the distance at the distal end of the apparatus between the first and second positions.

2. The apparatus of claim 1, wherein the hinged connection and the arms form a general U-shaped.

3. The apparatus of claim 1, wherein at least the planar arms are formed from a sheet material.

4. The apparatus of claim 3, wherein the material is at least one of a metal or plastic.

5. The apparatus of claim 3, wherein the material is stainless steel.

6. The apparatus of claim 1, wherein the hinge and the pair of arms are formed from a continuous sheet of material.

7. The apparatus of claim 1, wherein at least one of the arms has blade edge on a top side of the apparatus.

8. The apparatus of claim 1, wherein at least one of the arms has a generally U-shaped profile.

9. The apparatus of claim 1, wherein at least one of the arms has a concave top side.

10. The apparatus of claim 1, wherein at least one of the arms has a convex bottom side.

11. The apparatus of claim 1, wherein at least one of the arms has a concave top side having a curve with first radius and a convex bottom side with a curve having a second radius, the second radius greater than the first.

12. The apparatus of claim 11, wherein the concave top side has a blade edge thereon.

13. The apparatus of claim 11, wherein the radii are located such that the outer edges of the arms come to a point at the distal end of the slicer.

14. The apparatus of claim 1, wherein the planar arms are spaced between about ½ and about 3 inches from each other in the first position.

15. The apparatus of claim 1, wherein the planar arms are spaced between about 1 and about 2 inches from each other in the first position.

16. The apparatus of claim 1, wherein the hinge connection forms a flexible connection that allows the arms to move relative to each other with an application of a squeezing force applied at about the distal end of the apparatus.

17. The apparatus of claim 16, wherein the application of the squeezing force causes the arms to bend inwardly toward each other thereby shortening a distance between the arms and wherein removing the force causes the arms to return to the first position.

18. The apparatus of claim 1, comprising a handle portion molded over the arms and the hinge connection at the distal end of the apparatus.

19. The apparatus of claim 1, wherein at least one of the arms has an edge with a plurality of teeth located thereon.

20. The apparatus of claim 19, wherein the teeth lay in the same plane as the respective planar arm.
